(19) United States
(12) Patent Application Publication
(10) Pub. No.: US 2005/0269039 A1
(43) Pub. Date: Dec. 8, 2005

(54) Upper beam of roman drapery

(76) Inventor: Leslie Nien, Changhua Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/896,031

(22) Filed: Jul. 22, 2004

(30) Foreign Application Priority Data
Jun. 7, 2004 (CN) 093208944

(51) Int. Cl. E06B 3/48

(52) U.S. Cl. 160/84.01

(57) ABSTRACT

An upper beam of Roman drapery includes a Roman-type drapery made up of a drapery body with a coupling section of a proper length disposed at the top edge thereon for a telescopic upper beam to be mounted therein wherein at the rear side of the telescopic upper beam is equipped with a plurality of guide sliders exposed outside through holes of the coupling section, and at the front side of the telescopic upper beam is properly disposed a pulley set exposed outside a passage hole of the coupling section thereof for a plurality of pull cords to be collectively led there-through before individually wound through the guide sliders respectively for smooth operation thereof. The drapery body also has a plurality of folded sections equidistantly arranged at the rear side thereon for movable pieces having clamping parts disposed at one side to be properly attached thereto in alignment with the guide sliders thereof, and the movable pieces also have cord-passage holes disposed at the other side thereof for the pull cords to be sequentially led there-through till fixedly tied up to the bottommost ones thereof. Thus, the telescopic upper beam detachably engaged with the drapery body can be easily adjusted to any window frames, and the drapery body can be speedily replaced by a new one of different design without the upper beam being changed therewith, facilitating an easier and speedy assembly and achieving various decoration effect of the present invention to boost the competitive power thereof.

### BACKGROUND OF THE INVENTION

An upper beam of Roman drapery includes a Roman-type drapery made up of a drapery body with a coupling section of a proper length disposed at the top edge thereon for a telescopic upper beam to be mounted therein wherein the telescopic upper beam is equipped with a plurality of guide sliders exposed outside through holes of the coupling section at one side thereof, and a pulley set exposed outside a passage hole of the coupling section at the other side thereof for a plurality of pull cords to be collectively led there-through before individually wound through the guide sliders respectively for smooth operation thereof, and the drapery body is provided with a plurality of folded sections equidistantly arranged at the rear side thereon for movable pieces having clamping parts disposed at one side to be properly attached thereto in alignment with the guide sliders thereof; whereby, the movable pieces as well as the guide sliders and the pulley set thereof are properly adjusted in positions according to the telescopic upper beam to fit to any window frames, and the drapery body detachably engaged with the telescopic upper beam can be easily replaced by a new one without the upper beam being changed therewith, facilitating an easier and speedy assembly and achieving various decoration effect of the present invention to boost the competitive power thereof.

Please refer to FIG. 1. A conventional Roman drapery includes a Roman-type drapery 10 made up of an upper beam 11, and a drapery body 12 of a proper length and width fixedly attached to the underside of the upper beam 11 thereof wherein the drapery body 12 is sequentially folded backwards for a certain length and equidistantly seamed up into double layers to form a plurality of folded sections 13 from top to bottom thereon, and a plurality of retaining hoops 14 are symmetrically disposed at both left and right sides of the folded sections 13 thereon for both ends of a pull cord 15 to be led sequentially there-through till securely fixed to the bottommost retaining hoops 14 thereof. Thus, the pull cord 15 is drawn to actuate the bottommost retaining hoops 14, sequentially raising upwards the other retaining hoops 14 and the folded sections 13 therewith to gather up the drapery body 15 suspending downwards in multi-layers.

There are some drawbacks to such conventional Roman-type drapery 10. First, the drapery body 12 is directly fixed to the underside of the upper beam 11, and both the drapery body 12 and the upper beam 11 are unable to be adjusted according to the size of different window frames. In case the Roman-type drapery 10 purchased is unfit to the size of a window frame, the drapery 10 must be either replaced with a new one or made do for an improper window frame, which is inconveniently limited in decoration as well as assembly thereof Second, the drapery body 12, fixedly attached to the underside of the upper beam 11, must be dismantled along with the upper beam 11 in one set for the replacement of another drapery body 12 of different design, which is quite limited in the replacement thereof and may increase the cost in purchase. Third, the pull cord 15 is directly wound through the top surface of the upper beam 11 which tends to generate friction at the contact area between the pull cord 15 and the upper beam 11 and result in an awkward operation of the pull cord 15 easily got stuck in the process thereof Thus, great effort is required and wasted to activate the pull cord 15 in operation thereof

### SUMMARY OF THE PRESENT INVENTION

It is, therefore, the primary purpose of the present invention to provide an upper beam of Roman drapery, including a Roman-type drapery made up of a drapery body with a coupling section of a proper length disposed at the top edge thereon for a telescopic upper beam to be mounted therein wherein, via the design of movable pieces detachably mounted to folded sections of the drapery body thereof as well as guide sliders and a pulley set disposed at both sides of the telescopic upper beam thereof, the telescopic upper beam is properly adjusted in length, synchronically moving inwards the guide sliders and the pulley set and gathering up in natural wrinkles the drapery body between the guide sliders therewith so as to fit the Roman drapery thereof to any window frames and achieve the widespread use of the present invention thereof.

It is, therefore, the second purpose of the present invention to provide an upper beam of Roman drapery wherein the telescopic upper beam is detachably engaged with the coupling section of the drapery body thereof, permitting the drapery body to be easily replaced by a new one of various design without the upper beam being changed therewith, facilitating an easier and speedy assembly and achieving various decoration effect of the present invention to boost the competitive power thereof.

It is, therefore, the third purpose of the present invention to provide an upper beam of Roman drapery wherein a plurality of pull cords are collectively led through the pulley set of the upper beam before individually wound through the guide sliders thereof respectively to avoid the friction problem of the above conventional Roman drapery, facilitating a smoother and effort-saving operation thereof.

### BRIEF DESCRIPTION OF THE DRAWINGS

FIG. 1 is a perspective view of a conventional Roman drapery.

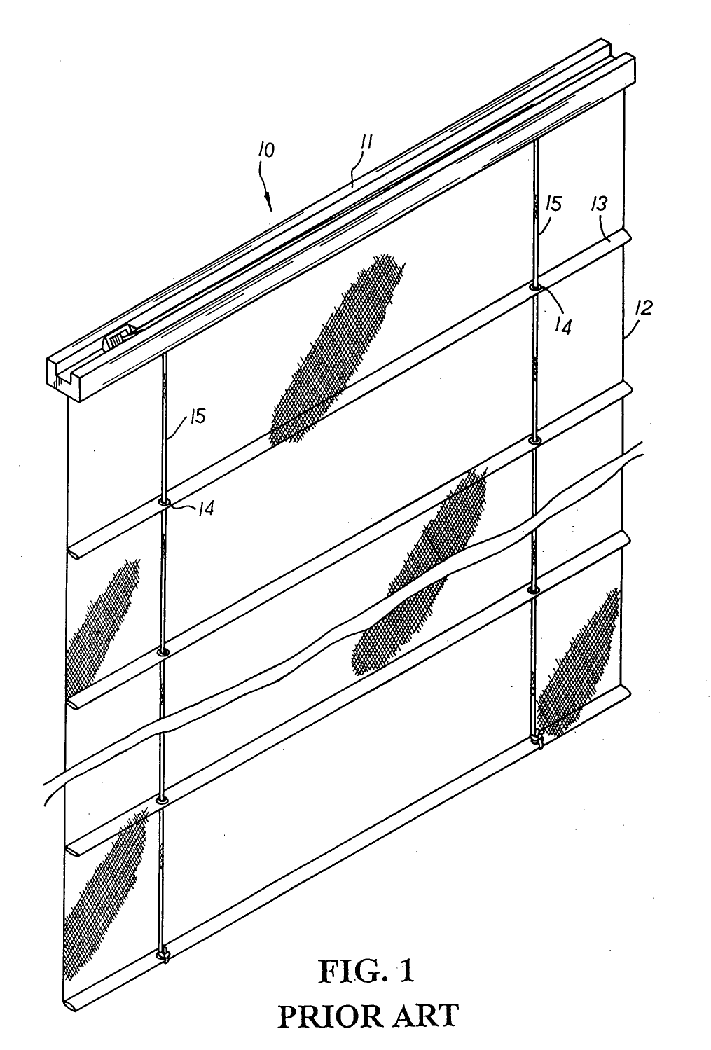

FIG. 2 is a perspective view of the present invention.

FIG. 3 is a diagram showing the present invention gathered up in operation.

FIG. 4 is a diagram showing the present invention gathered up at one side in operation.

FIG. 5 is a diagram showing the present invention adjusted according to the size of a widow frame.

### DETAILED DESCRIPTION OF THE PREFERRED EMBODIMENTS

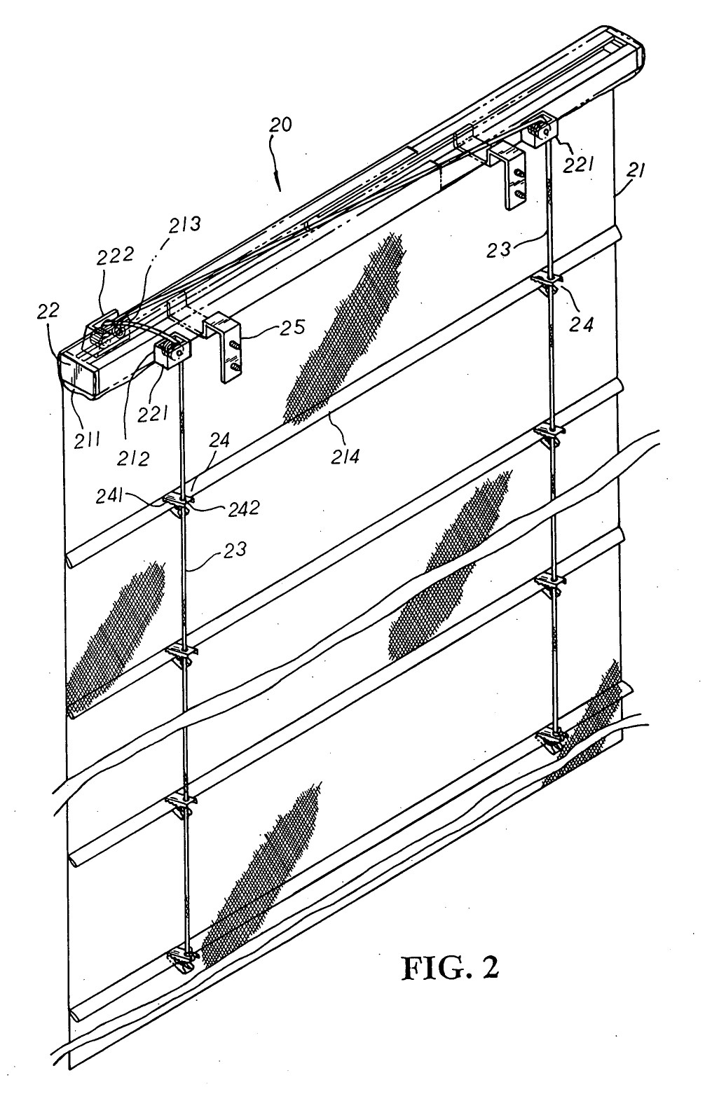

Please refer to FIG. 2. The present invention is related to an upper beam of Roman drapery, including a Roman-type drapery 20 made up of a drapery body 21 having a coupling section 211 of a proper length disposed at the top edge thereon for a telescopic upper beam 22 to be mounted therein wherein the coupling section 211 thereof is better made into a hollow tubular passage. At the back side of the hollow coupling section 211 thereof is properly disposed a plurality of through holes 212 corresponding to a plurality of guide sliders 221 mounted at the rear side of the telescopic upper beam 22 with each guide slider 221 thereof exposed precisely outside the through hole 212 thereof, and at one front lateral side of the coupling section 211 is provided with a passage hole 213 for a pulley set 222 of the telescopic upper beam 22 to be led there-through and exposed at the outer side thereof. A plurality of pull cords 23 with pulling sections preset for a certain length to suspend downwards at the front side of the drapery body 21 (without shown in the diagram) are collectively led through the pulley set 222 at the other ends before extending individually to wind through the guide sliders 221 and suspending downwards there-from respectively. A the rear side of the drapery body 21 thereof is equidistantly seamed with a plurality of folded sections 214 each having a plurality of movable pieces 24 with clamping parts 241 disposed at one side to be detachably located at preset positions of the folded sections 214 thereon in alignment with the guide sliders 221 thereof. The movable pieces 24 are equipped with cord-passage holes 242 at one side for the pull cords 23 to be sequentially led there-through before fixedly tied up to the bottommost cord-passage holes 242 thereof A plurality of retaining brackets 25 are mounted at the bottom side of the telescopic upper beam 22 and fixedly attached to the upper sidewall of a window frame thereby.

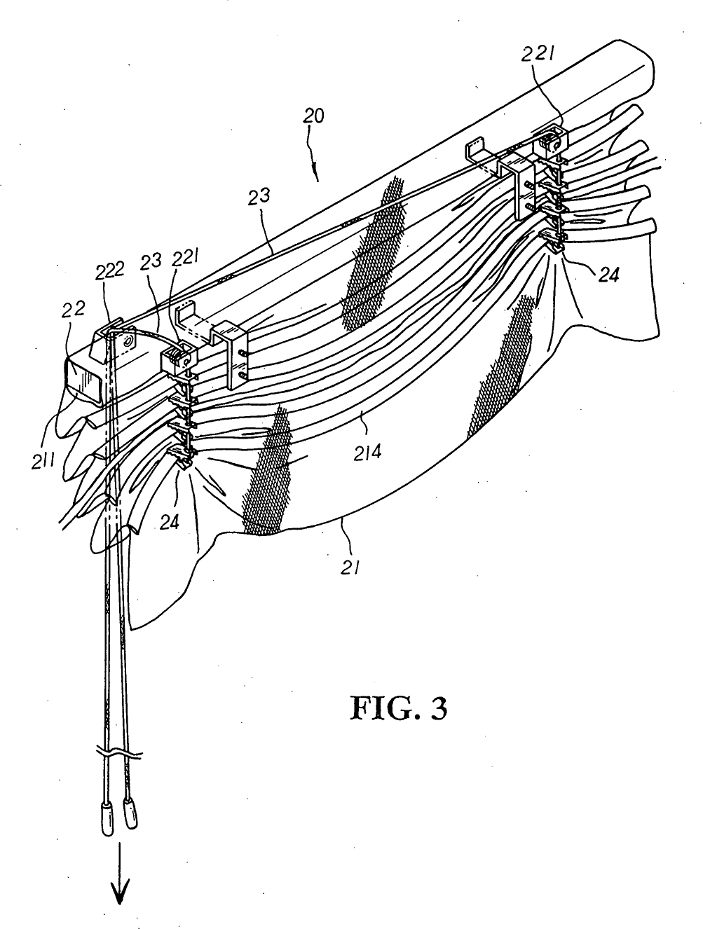

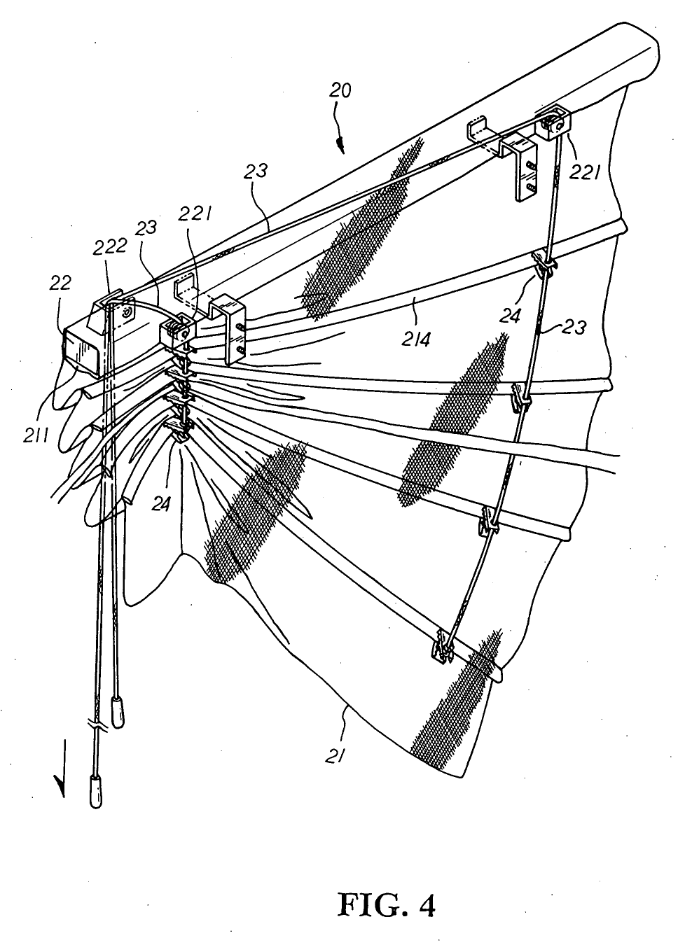

Please refer to FIGS. 3 to 4 inclusive. The pull cords 23 are individually wound through the guide sliders 221 respectively so as to prevent the friction generated between the pull cords 23 and the telescopic upper beam 22 in the down-pulling or up-lifting operation of the pull cords 23, facilitating a smoother and more effort-saving operation thereof. Besides, to collect the drapery body 21 thereof, the pull cords 23 are synchronically drawn downwards to sequentially raise upwards the movable pieces 24 and synchronically gather upwards the folded sections 214 of the drapery body 21, folding up the drapery body 21 therewith in multi-layer suspension thereby as shown in FIG. 3. Otherwise, only one pull cord 23 is drawn downwards at one side of the drapery body 21, collecting simply one half of the drapery body 21 with the other half thereof suspending downwards in a natural arc shape as shown in FIG. 4, providing versatile changes in patterns and light-penetrating space of the Roman drapery 20 thereof.

Please refer to

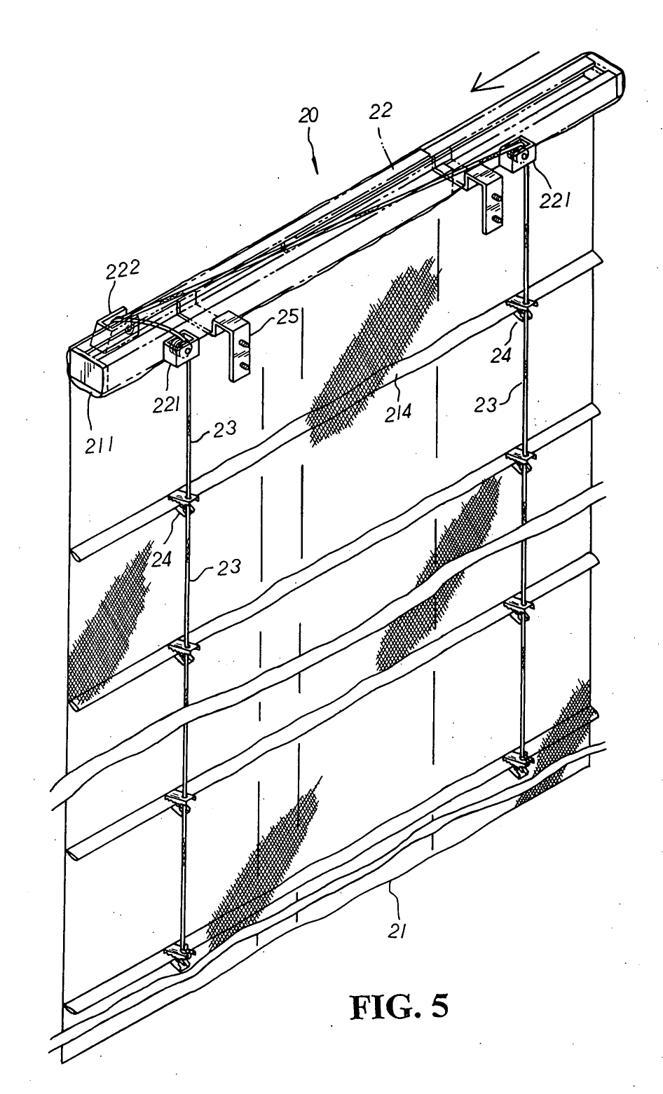

FIG. 5. The telescopic upper beam 22 is adjustably fit to window frames of various sizes with the movable pieces 24 as well as the guide sliders 221 and the pulley set 222 disposed at both sides of the telescopic upper beam 22 properly adjusted therewith according to the window frames. When the telescopic upper beam 22 is adjusted shorter to fit to a window frame, the guide sliders 221 and the pulley set 222 are synchronically moved inwards accordingly with the drapery body 21 between the adjusted guide sliders 221 thereof gathered up in natural wrinkles for proper assembly thereof. Thus, the Roman drapery 20 thereof can be easily adjusted and mounted to any window frames by a user without any expertise required, facilitating an easier and speedy assembly of the present invention for more widespread use thereof. Besides, with the telescopic upper beam 22 detachably engaged with the coupling section 211 of the drapery body 21, the Roman drapery 20 thereof can have the drapery body 21 replaced by a new one of different design in an easy and speedy manner without the upper beam 22 being changed therewith, economically reducing the cost of the Roman drapery 20 in assembly and replacement thereof as well as achieving various decoration effect to boost the competitive power thereof.

1. An upper beam of Roman drapery, including a Roman-type drapery having a drapery body with a coupling section of a proper length disposed at the top edge thereon for a telescopic upper beam to be mounted therein wherein at the rear side of the telescopic upper beam is equipped with a plurality of guide sliders exposed outside the coupling section thereof for a plurality of pull cords to be wound there-through for smooth operation thereof, and at the rear side of the drapery body has a plurality of folded sections equidistantly arranged thereon for movable pieces to be properly attached thereto in alignment with the guide sliders thereof, the pull cords, sequentially led through cord-passage holes of the movable pieces till fixedly tied up to the bottommost ones thereof, have pull sections suspending downwards at the front side of the drapery body thereof, facilitating an easy and speedy operation of the present invention in various patterns of display.

2. The upper beam of Roman drapery as claimed in claim 1 wherein the coupling section of the drapery body thereof is better made into a hollow tubular passage.

3. The upper beam of Roman drapery as claimed in claim 1 wherein the hollow coupling section of the drapery body is provided with a plurality of through holes for the guide sliders of the telescopic upper beam to be exposed outside the coupling section there-through.

4. The upper beam of Roman drapery as claimed in claim 1 wherein a plurality of retaining brackets are mounted at the bottom side of the telescopic upper beam and fixedly attached to the upper sidewall of a window frame thereby.

5. The upper beam of Roman drapery as claimed in claim 1 wherein each movable piece has a clamping part extending at the other side of the cord-passage hole thereof.
